(19) United States
(12) Patent Application Publication
(10) Pub. No.: US 2011/0116021 A1
(43) Pub. Date: May 19, 2011

(54) LIQUID CRYSTAL DISPLAY DEVICE

(75) Inventors: Chieko Araki, Hitachi (JP); Tatsuya Sugita, Takahagi (JP); Masaya Adachi, Hitachi (JP)

(73) Assignee: Hitachi Displays, Ltd.,

(21) Appl. No.: 12/943,157

(22) Filed: Nov. 10, 2010

(30) Foreign Application Priority Data
Nov. 13, 2009 (JP) 2009-259830

(51) Int. Cl. G02F 1/1335

(52) U.S. Cl. 349/96

(57) ABSTRACT

A liquid crystal display device includes light source sections 150, a light guide plate 130 guiding light of the light source sections from a side edge and including a light emitting surface, and a liquid crystal panel 200 including a lower polarizer 230 opposed to the light emitting surface. The lower polarizer has a transmission axis generally along a light guide azimuth in which the light guide plate guides the light. The light guide plate includes a polarization converting section 131 on at least one of the light emitting surface and a rear surface. The polarization converting section reflects light made incident from the light guide azimuth in a different traveling azimuth and further reflects the light reflected in the different traveling azimuth to bring the traveling azimuth closer to the light guide azimuth to thereby convert polarization of the light traveling from the light guide azimuth.

### CROSS-REFERENCE TO RELATED APPLICATION

The present application claims priority from Japanese application JP2009-259830 filed on Nov. 13, 2009, the content of which is hereby incorporated by reference into this application.

### BACKGROUND OF THE INVENTION

1. Field of the Invention

The present invention relates to a liquid crystal display device that guides light from a light source of a side light type and supplies the light to a liquid crystal panel.

2. Description of the Related Art

In general, a liquid crystal display device is thin, light, and low power consumption. Therefore, the liquid crystal display device is used as a display device for a wide range of electronic apparatuses such as a notebook personal computer, a portable information terminal, a cellular phone, a digital camera, a monitor for a computer, and a thin television.

Unlike a self-emitting display device such as a cathode ray tube or a plasma display device, such a liquid crystal display device controls amount of light of a light made incident from the outside and displays an image and the like. If color filters for a plurality of colors are provided as light control elemental devices, the liquid crystal display device can perform color display in multiple colors.

The liquid crystal display device applies, in a liquid crystal panel including a liquid crystal cell in which a liquid crystal layer is held between a pair of substrates and polarizers respectively arranged on surfaces of the substrates on the opposite sides of the liquid crystal layer, an electric field to the liquid crystal layer to thereby change a polarization state of light made incident on the liquid crystal layer and controls a transmission amount of the light to thereby display an image.

The polarizers have a function of absorbing a predetermined linearly polarized light component and transmitting linearly polarized light having an oscillation plane orthogonal to the predetermined linearly polarized light component. Therefore, when light from a back light irradiated on the liquid crystal panel is non-polarized light, at least 50% of illumination light is absorbed by the polarizer on an incident side of the liquid crystal panel (a lower polarizer). In other words, in the liquid crystal display device, when light emitted from the back light is non-polarized light, about a half of the illumination light is absorbed by the polarizer and lost. Therefore, a ratio of the illumination light from the backlight absorbed by the lower polarizer in the liquid crystal panel is reduced, whereby a liquid crystal display device that displays a brighter image and consumes lower power is realized.

As the back light of the liquid crystal display device, there are a side light type (a light guide type), a direct type (a reflector type), and a surface light source type. To realize a thin back light, the side light type is used.

The liquid crystal display device of the side light type includes a tabular transparent member called light guide plate, a linear or point-like light source provided at an end of the light guide plate, an optical sheet called prism sheet that adjusts a traveling direction of light from the light guide plate, and a diffusion sheet. The light guide plate has a function of emitting the light from the light source in a planar shape.

As a technique for performing polarization conversion in the light guide plate, JP 10-20125 A discloses a configuration in which a birefringence layer is provided in the light guide plate.

### SUMMARY OF THE INVENTION

As in the related art, a polarization component that tends to remain in the light guide plate is subjected to polarization conversion, whereby light remaining in the light guide plate decreases and light utilization efficiency of the back light increases.

The light guide plate is formed by using, for example, transparent resin as a material. When stress or the like is applied when the light guide plate is formed, birefringence properties can be imparted to the light guide plate itself. To convert polarization of the light from the light source in the light guide plate using the birefringence properties imparted to the light guide plate itself, a phase difference and a principal refractive index of the light guide plate are designed while directions thereof are uniformalized.

However, a method of controlling the directions of the phase difference and the principal refractive index having the birefringence properties is different depending on a manufacturing method. Further, in some case, in-plate distributions in the directions of the phase difference and the principal refractive index are not uniform. Therefore, it is difficult to manufacture the light guide plate imparted with the birefringence properties in order to properly convert the polarization of the light from the light source.

The present invention has been devised in view of the above problems and it is an object of the present invention to provide a liquid crystal display device with light utilization efficiency of a back light improved by including a light guide plate that has a function of converting polarization of light from a light source and can be simply and easily manufactured.

In order to solve the problem, a liquid crystal display device according to the present invention includes: one or a plurality of light source sections; a light guide plate including a light emitting surface that guides, from a side edge, light from the one or plurality of light source sections and emits the light in a planar shape; and a liquid crystal panel including a lower polarizer on a side opposed to the light emitting surface. The lower polarizer has a transmission axis in a direction generally along a light guide azimuth in which the light guide plate guides the light. The light guide plate includes a polarization converting section on at least one of the light emitting surface and a rear surface of the light emitting surface. The polarization converting section reflects light made incident from the light guide azimuth in a different traveling azimuth and further reflects the light reflected in the different traveling azimuth to bring the traveling azimuth closer to the light guide azimuth to thereby convert polarization of the light traveling from the light guide azimuth.

In an aspect of the liquid crystal display device according to the present invention, the polarization converting section may include a prism having at least two slopes including a slope that reflects the light made incident from the light guide azimuth in the different traveling azimuth and a slope that further reflects the light reflected in the different traveling azimuth to bring the traveling azimuth closer to the light guide azimuth.

In another aspect of the liquid crystal display device according to the present invention, the prism may be formed in a triangular shape in cross-section by the at least two slopes, and normal lines of the at least two slopes may be in an azimuth different from the light guide azimuth.

In still another aspect of the liquid crystal display device according to the present invention, the prism may be formed in a shape of a linear groove extending in an azimuth different from an azimuth perpendicular to the light guide azimuth.

In still another aspect of the liquid crystal display device according to the present invention, the polarization converting section may include a prism row in which a plurality of the prisms are formed in a row, and each of the prisms in the prism row may have a shape of a liner groove extending in an azimuth different from an azimuth perpendicular to the light guide azimuth.

In still another aspect of the liquid crystal display device according to the present invention, the prism may be formed in an isosceles triangular shape in cross-section, and the at least two slopes may be formed symmetrical.

In still another aspect of the liquid crystal display device according to the present invention, an angle formed by the azimuth in which each of the prisms extends and the light guide azimuth may be equal to or smaller than 10 degrees, and an apex angle b of the prism formed in a triangular shape in cross section may be in a range of 80 degrees≦b≦130 degrees.

In still another aspect of the liquid crystal display device according to the present invention, the apex angle b may be in a range of 80 degrees≦b≦100 degrees.

In still another aspect of the liquid crystal display device according to the present invention, the apex angle b may be in a range of 110 degrees≦b≦130 degrees.

In still another aspect of the liquid crystal display device according to the present invention, the light emitting surface and the rear surface of the light guide plate may be formed smooth, and the at least two slopes of the prism included in the polarization converting section may be formed smooth.

In still another aspect of the liquid crystal display device according to the present invention, the light guide plate may include a plurality of emitting sections that make light traveling on the inside of the light guide plate in the light guide azimuth incident on the light emitting surface at an angle smaller than a critical angle to thereby emit the light from the light emitting surface.

In still another aspect of the liquid crystal display device according to the present invention, the plurality of emitting sections may reflect, in the light guide azimuth, the light traveling on the inside of the light guide plate in the light guide azimuth and make the light incident on the light emitting surface at an angle smaller than the critical angle.

In still another aspect of the liquid crystal display device according to the present invention, the plurality of emitting sections may be discontinuously arranged in a plurality of places on the light emitting surface or the rear surface.

In still another aspect of the liquid crystal display device according to the present invention, the polarization converting section and the plurality of emitting sections may be arranged on the rear surface.

In still another aspect of the liquid crystal display device according to the present invention, a groove-like pattern may be formed linearly along the light guide azimuth according to the arrangement of the one or plurality of light source sections.

In still another aspect of the liquid crystal display device according to the present invention, the polarization converting section may include a prism row in which a plurality of the prisms are formed in a row, each of the prisms in the prism row may have a shape of a liner groove extending in an azimuth different from an azimuth perpendicular to the light guide azimuth, and the plurality of emitting sections may be respectively arranged to overlap a ridge line and a valley line in the prism row.

In still another aspect of the liquid crystal display device according to the present invention, the light guide plate may include the polarization converting section on the rear surface, the polarization converting section may include a plurality of prism rows in which a plurality of the prisms are formed in rows, each of the prisms in each of the prism rows may have a shape of a linear groove extending in an azimuth different from an azimuth perpendicular to the light guide azimuth, the plurality of prism rows may be discontinuously arranged along the light guide azimuth, and at least one of the plurality of emitting sections may be arranged to be interposed between two of the plurality of prism rows discontinuously arranged.

In still another aspect of the liquid crystal display device according to the present invention, a reflective polarizer may be arranged between the lower polarizer and the light guide plate, the reflective polarizer may reflect light of a polarization component in a direction orthogonal to the transmission axis to the light guide plate side, and the polarization converting section may be formed on the rear side of the light guide plate.

In one aspect of the liquid crystal display device according to the present invention, the light guide plate may include a polarization converting section that totally reflects, at least twice, light traveling on the inside of the light guide plate in the light guide azimuth to change a traveling azimuth of the light and converts polarization of the light.

According to the present invention, it is possible to provide a liquid crystal display device with light utilization efficiency of a back light improved by including a light guide plate that has a function of converting polarization and can be simply and easily manufactured.

### BRIEF DESCRIPTION OF THE DRAWINGS

FIG. 1 is a diagram showing a state in which components included in a liquid crystal display device according to a first embodiment are separated;

FIG. 2 is a plan view showing a schematic configuration of a surface light source according to the first embodiment;

FIG. 3 is a diagram showing a state of light L1 emitted from a light emitting surface of a light guide plate;

FIG. 4 is an explanatory diagram of light emitted from an interface;

FIG. 5 is a graph showing dependency of a phase difference between a p-polarization component and an s-polarization component on an angle of incidence θ1 in light made incident on the interface from the inside of the light guide plate and emitted from the interface;

FIG. 6A is a diagram showing a state in which p-polarization and s-polarization are made incident on a prism substrate, on a rear side of which prisms having an isosceles triangular shape in cross-section are formed in a row;

FIG. 6B is a graph showing a result obtained by examining degrees of polarization of emitted lights of the p-polarization and the s-polarization made incident on the prism substrate;

FIG. 7A is a diagram showing a state in which a reflective sheet side of the light guide plate according to the first embodiment is faced up;

FIG. 7B is a diagram showing a cross section taken along line 7B-7B in FIG. 7A;

FIG. 7C is a diagram showing a cross section taken along line 7C-7C in FIG. 7A;

FIG. 7D is a diagram showing a state in which the reflective sheet side of the light guide plate according to the first embodiment is faced up;

FIG. 8 is a diagram showing a result obtained by examining a relation between a degree of polarization of emitted light and an apex angle b when s-polarization is made incident from an azimuth of φ=90° on a prism substrate, on a rear side of which prisms having a ridge line in the azimuth of φ=90° and having an isosceles triangular shape in cross-section are formed in a row;

FIG. 9 is a cross-section in which a part of a prism sheet according to the first embodiment is enlarged;

FIG. 10A is a diagram showing a state in which a prism sheet side of a light guide plate according to a second embodiment is faced up;

FIG. 10B is a diagram showing a state in which a reflective sheet side of the light guide plate according to the second embodiment is faced up;

FIG. 11A is a diagram showing a state in which a reflective sheet side of a light guide plate according to a third embodiment is faced up;

FIG. 11B is a diagram showing a state in which a prism sheet side of the light guide plate according to the third embodiment is faced up;

FIG. 11C is a diagram showing another state in which the reflective sheet side of the light guide plate according to the third embodiment is faced up;

FIG. 12A is a diagram showing a state in which a reflective sheet side of a light guide plate according to a fourth embodiment is faced up;

FIG. 12B is a diagram showing a state in which a prism sheet side of the light guide plate according to the fourth embodiment is faced up;

FIG. 13 is a schematic diagram of a state in which components included in a liquid crystal display device according to a fifth embodiment are separated;

FIG. 14 is a diagram showing a state in which a cross section of a prism sheet according to the fifth embodiment is enlarged;

FIG. 15 is a diagram showing a state in which components included in a liquid crystal display device according to a sixth embodiment are separated;

FIG. 16 is a diagram showing a state in which components included in a liquid crystal display device according to a seventh embodiment are separated; and

FIG. 17 is a cross-section in which a part of a prism sheet according to the seventh embodiment is enlarged.

### DETAILED DESCRIPTION OF THE INVENTION

Liquid crystal display devices according to embodiments of the present invention are explained below with reference to the accompanying drawings. The present invention is not limited by the embodiments and may be carried out indifferent forms within a scope of a technical idea of the present invention. Combined forms of the embodiments are also included in the present invention.

### First Embodiment

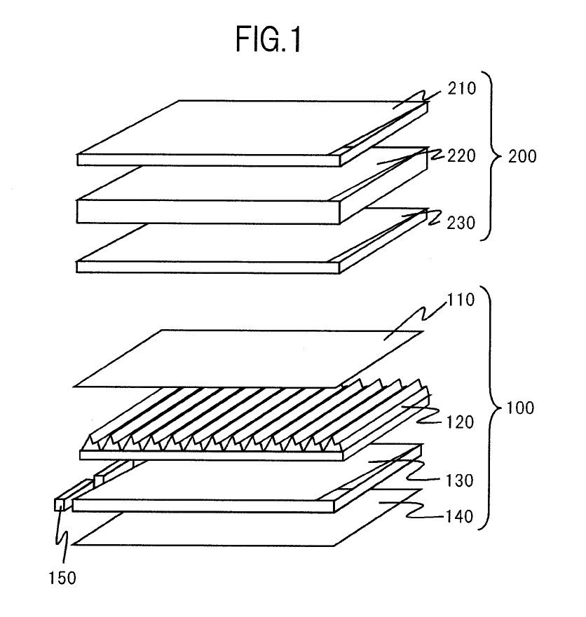

FIG. 1 is a diagram showing a state in which components included in a liquid crystal display device according to this embodiment are separated. As shown in the figure, the liquid crystal display device according to this embodiment includes a liquid crystal panel 200 and a surface light source (a back light) 100. The liquid crystal panel 200 includes a liquid crystal cell 220, an upper polarizer 210 provided on an observer side of the liquid crystal cell 220, and a lower polarizer 230 provided on the surface light source 100 side of the liquid crystal cell 220. The surface light source 100 includes a diffusion sheet 110, a prism sheet 120, a light guide plate 130, a reflective sheet 140, and a light source section 150.

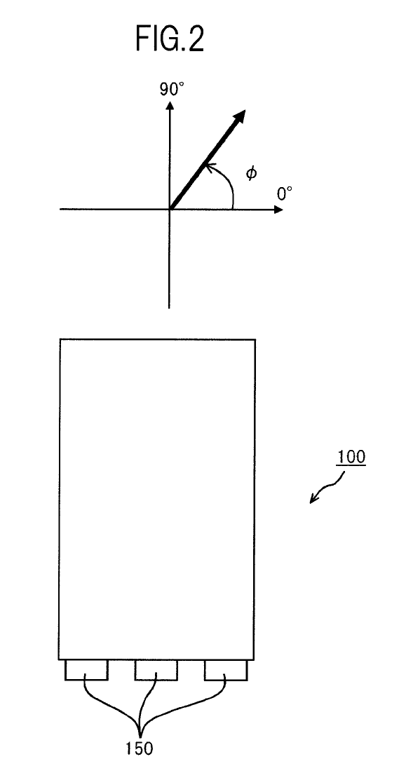

FIG. 2 is a plan view showing a schematic configuration of the surface light source 100 according to this embodiment. A definition of an azimuth angle φ is also written in the figure. As shown in the figure, a reference (0 degree) is provided in parallel to a side of a light guide plate on which the light source sections 150 are arranged. The azimuth angle φ is defined counterclockwise viewed from the liquid crystal panel 200 side. The surface light source 100 is an illumination device that is thin and can emit illumination light having a large ratio of a predetermined polarization component. The surface light source 100 irradiates light on a display area of the liquid crystal panel 200 from a rear side of the liquid crystal panel 200. In order to evenly illuminate the display area, a light emitting surface (a light radiating surface) of the surface light source 100 is desirably formed in a shape substantially the same as the shape of the display area.

In FIG. 1, in the surface light source 100 according to this embodiment, a light incident surface is formed on a side of the light guide plate 130. The light source sections 150 are arranged near the light incident surface in order to make light incident from the light incident surface. The reflective sheet 140 is arranged on the rear side of the light guide plate 130 and the prism sheet 120 and the diffusion sheet 110 are arranged on the upper side of the light guide plate 130. The liquid crystal panel 200 includes the upper polarizer 210, the lower polarizer 230, and the liquid crystal cell 220 held between the upper polarizer 210 and the lower polarizer 230.

Directions of absorption axes of the upper polarizer 210 and the lower polarizer 230 are arranged to be orthogonal to each other. A transmission axis of the lower polarizer 230 is provided to be generally parallel to a light guide azimuth of the surface light source 100. The light guide azimuth is an azimuth in which a principal ray of the light source sections 150 is propagated. In this embodiment, the light guide azimuth is an azimuth perpendicular to the side of the light guide plate 130 on which the light source sections 150 are arranged. The light guide azimuth is a direction at an azimuth angle φ=90 degrees. As explained later, a polarization component perpendicular to the light guide azimuth is reflected on the light emitting surface of the light guide plate 130 at a higher ratio than a polarization component parallel to the light guide azimuth. Therefore, the light guide plate 130 emits, on the light emitting surface, illumination light having a large ratio of a polarization component in the light guide azimuth. The transmission axis of the lower polarizer 230 is aligned in a direction along the light guide azimuth. The transmission axis of the lower polarizer 230 and the light guide azimuth do not always have to be set the same, polarized light intensely emitted from the light guide plate 130 has to be allowed to be effectively transmitted through the lower polarizer 230. If an angle between the transmission axis of the lower polarizer 230 and the light guide azimuth is set to be equal to or smaller than 45 degrees, an effect can be obtained. Desirably, if the angle is set to be equal to or smaller than 20 degrees or set to be equal to or smaller than 10 degrees, it is possible to effectively utilize the polarized light intensely emitted from the light guide plate 130. In these cases, the transmission axis of the lower polarizer 230 can be regarded as being generally along the light guide azimuth.

The liquid crystal cell 220 includes a first substrate including color filter, a second substrate including active matrix elemental devices or the like arrayed in a matrix shape, a liquid crystal layer held between the first substrate and the second substrate, a driver IC for driving the active matrix elemental devices and the liquid crystal layer, and a flexible printed board for supplying a signal source and a power supply to the driver IC and the like (these are not shown in FIG. 1). To configure the surface light source 100 and the liquid crystal panel 200, mechanical structures such as a frame and electrical structures such as a power supply and wires necessary for causing a light source to emit light. General means only has to be used for the mechanical structures and the electrical structures. Detailed explanation of the mechanical structures and the electrical structures in this specification are omitted.

As the light source sections 150, it is advisable to use light source sections that satisfy conditions such as small size, high light emission efficiency, and low heat generation. As such light sources, fluorescent lamps or light emitting diodes (LEDs) are suitable. The light source sections 150 in this embodiment are formed in a rectangular shape according to the shape of the light emitting diodes and plastic bodies for sealing the light emitting diodes. Light is radiated from the light source sections 150 to have higher directivity in the direction of the azimuth angle 90 degrees, which is the light guide azimuth, than other directions. In the explanation of this embodiment, the light emitting diodes are used as the light source sections 150. However, the present invention is not limited to this. When the light emitting diodes are used as the light source sections 150, since the light emitting diodes are point-like light sources, the light source sections 150 may be arranged by a number (three in FIG. 1 but the present invention is not limited to this) corresponding to necessity on an end face of the light guide plate 130. An optical elemental device that converts light from the light emitting diodes into a linear light source having high directivity in the light guide direction may be arranged between the light emitting diodes and the light guide plate 130.

As light sources of the light source sections 150, light emitting diodes that emit white light can be used. As the light emitting diodes that realize the white emitted light, light emitting diodes that realize the white emitted light by combining blue emitted light and a phosphor that is excited by the blue light and emits yellow light can be used. Alternatively, light emitting diodes that realize white emitted light having a light emission peak wavelength in blue, green, and red by combining blue or ultraviolet emitted light and a phosphor that is excited by the emitted light and emits light can be used. When the liquid crystal display device including the surface light source 100 realizes color display through additive color mixture, it is advisable to use light emitting diodes that emit light of three primary colors of red, blue, and green as the light sources of the light source sections 150. For example, when a color liquid crystal panel is used as an irradiation target of illumination light, it is possible to realize a liquid crystal display device having a wide color reproduction range by using the light source sections 150 having a light emission peak wavelength corresponding to a transmission spectrum of a color filter of the liquid crystal panel. When color display is realized by color field sequential, it is unnecessary to provide a color filter, which is a cause of an optical loss, on the liquid crystal panel 200. Therefore, it is possible to realize a display device having a small optical loss and a wide color reproduction range by using the light emitting diodes that emit the three primary colors of red, blue, and green. The light source sections 150 are connected to a power supply and a control unit that controls turn-on and turn-off (both of which are not shown in the figure) through wires.

The reflective sheet 140 is used as a reflecting section according to this embodiment. For example, a metal film having high reflectance such as aluminum or silver formed on a resin plate or a supporting base material of a polymer film by evaporation, sputtering or the like, a dielectric multilayer film formed to be a reflection increasing film, or the supporting base material coated with white pigment is used. Transparent media having different refractive indexes laminated by a plurality of layers to function as the reflecting section may be used. The reflective sheet 140 is arranged on the rear surface of the light guide plate 130 (a surface on the opposite side on which the liquid crystal panel 200 is arranged) and has a function of reflecting light emitted from the rear side of the light guide plate 130 and returning the light to the inside of the light guide plate 130.

The azimuth angle γ is explained in a plan view (FIG. 2) of the surface light source 100 observed from the liquid crystal panel 200 side. When the surface light source 100 is viewed from the liquid crystal panel 200 side, it is assumed that a direction in which the light source sections 150 are set is a direction of 6 o'clock and a direction on the opposite side is a direction of 12 o'clock. In this case, a direction of 3 o'clock is defined as φ=0°. In other words, a direction in which the light source sections 150 are set is φ=270° and the opposite side is φ=90°.

The light guide plate 130 has a function of emitting light in a plane shape by, while guiding light emitted from the light source sections 150 made incident from the light incident surface, emitting a part of the light from the light emitting surface on the front side. Therefore, the light guide plate 130 is formed of a tabular member transparent to visible light. In the light guide plate 130, emitting sections as structures for emitting light, which is made incident from the light incident surface and totally reflected on the light emitting surface and the rear surface and guided in the light guide plate 130, to the light emitting surface on the front side are provided on the surface of one of the prism sheet 120 side and the reflective sheet 140 side of the light guide plate 130. The emitting sections reflect the light guided on the inside of the light guide plate such that the light is made incident on the light emitting surface at an angle smaller than a critical angle. The emitting sections in this embodiment are configured by forming slopes tilting at a predetermined angle (0.5 to 3 degrees) with respect to the light emitting surface on at least a part of the rear surface of the light guide plate 130. When the slopes are formed on the rear surface of the light guide plate 130, the emitting sections may be configured by tilting the entire rear surface at the angle. The emitting sections may be configured by discontinuously or locally arranging the slopes tilting at the angle. The slopes tilting at the predetermined angle formed as the emitting sections may be formed to be recessed in the light emitting surface or the rear surface or may be formed to be projected from the light emitting surface or the rear surface. The normal line of the slope tilts in an azimuth of φ=270 degrees. The directivity of the surface light source 100 can be improved by forming such emitting sections on the light guide plate.

The light guide plate 130 is formed by using a resin material transparent to visible light. For example, acrylic resin, polycarbonate resin, or cyclic olefin resin is used as the resin material. Polarization converting sections having a function of converting a polarization state of guided light are provided in the light guide plate 130. The polarization converting sections may be provided on the prism sheet 120 side or the reflective sheet 140 side of the light guide plate 130. In this embodiment, the polarization converting sections are provided together with the emitting sections on the rear surface on the reflective sheet 140 side. The polarization converting sections are explained in detail later.

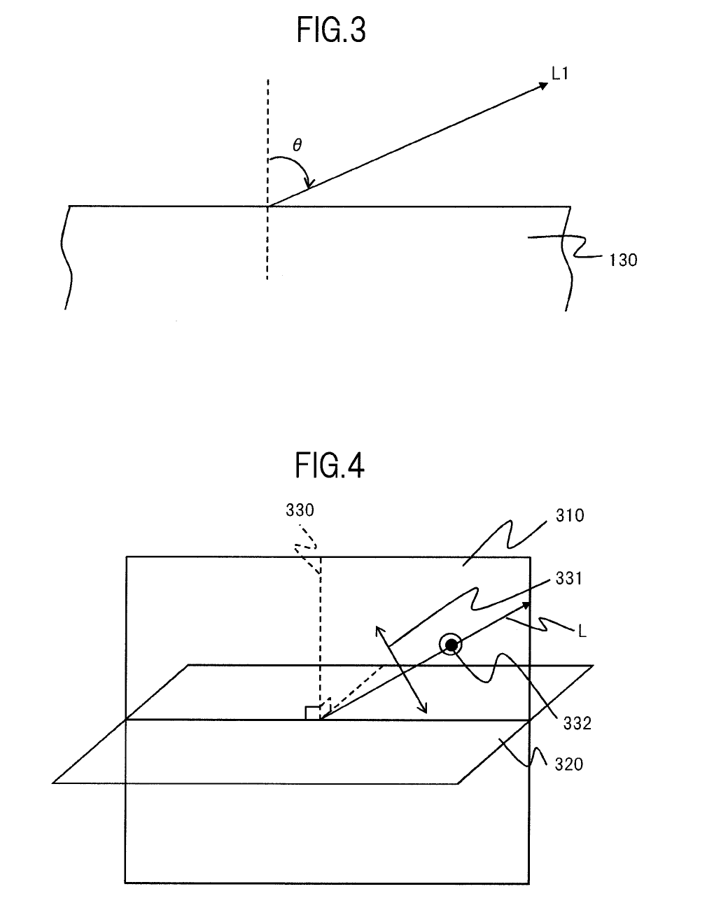

FIG. 3 is a diagram showing a state of light L1 emitted from the light emitting surface of the light guide plate 130. In the figure, a polar angle (a view angle) θ of the light L1 is defined with a perpendicular (normal line) direction of the light emission surface of the light guide plate 130 set to 0°. In the light guide plate 130 used in the surface light source 100 in this embodiment, a direction in which the luminance or the luminous intensity of light emitted from the light emitting surface is the maximum is at the azimuth angle φ of about 90° and at the polar angle (the view angle) θ of 60 to 80°. Among lights emitted from the light guide plate, in light emitted at an emission angle (a peak angle) at which the luminance or the luminous intensity is the maximum and an angle near the emission angle, a polarization component in a φ=0° direction, which is a direction perpendicular to the light guide direction, is reflected on the light emitting surface of the light guide plate at a larger ratio than a polarization component in a φ=90° direction, which is a direction parallel to the light guide direction. When an emission angle θ of light, the luminance or the luminous intensity of which is the maximum, tilts from the perpendicular (normal line) direction of the light emission surface of the light guide plate 130, emitted light having a large ratio of a polarization component in the φ=90° direction, which is the direction parallel to the light guide direction, is obtained. In this way, in the light emitted in the direction tilting with respect to the perpendicular direction of the light emission surface of the light guide plate 130, the polarization component in the φ=90° direction, which is the direction parallel to the light guide direction, is larger than the polarization component in the φ=0° direction, which is the direction perpendicular to the light guide direction. As it is generally known, this is because, when the light is refracted on the interface between the light guide plate 130 and the air, transmittances of the polarization component in the φ=90° direction and the polarization component in the φ=0° direction are different.

Maximum luminance and minimum luminance obtained by measuring, through an analyzer (a polarizer), the luminance of light emitted from the light guide plate 130, the prism sheet 120, or the like while rotating the analyzer are respectively represented as Imax and Imin, a degree of polarization P is represented by the following Formula (1):

$$P = \frac{{I}_{max} - {I}_{min}}{{I}_{max} + {I}_{min}} \qquad ( 1 )$$

FIG. 4 is a diagram showing emitted light L from an interface (a light emitting surface) 320 of the light guide plate 130. In the figure, a plane including a perpendicular (a normal line) 330 of a light emission surface of the interface and a traveling direction of the light emitted from the interface 320 is shown as a plane of incidence 310. It is generally known that linearly polarized light including an oscillation direction of an electric vector of the light L in the plane of incidence 310 is represented as p-polarization 331 and linearly polarized light orthogonal to the p-polarization 331 and the oscillation direction of the electric vector is represented as s-polarization 332. In FIG. 4 and FIGS. 5 and 6 referred to later, it is assumed that a p-polarization direction is a direction including the oscillation direction of the electric vector of the light L and parallel to the plane of incidence and an s-polarization direction is a direction orthogonal to the oscillation direction of the electric vector of the light L and perpendicular to the plane of incidence. Unless specifically noted in this specification, in the following explanation, it is assumed that a polarization direction as the azimuth of φ=90 degrees is the p-polarization direction and a polarization direction as the azimuth of φ=0 degree perpendicular to the p-polarization direction is the s-polarization direction.

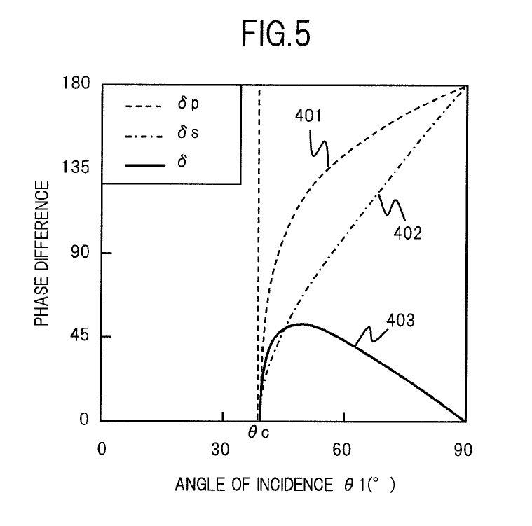

FIG. 5 is a graph showing dependency of a phase difference between a p-polarization component parallel to the place of incidence and an s-polarization component perpendicular to the plane of incidence (a difference between advance δp of a phase angle of the p-polarization component and advance δs of a phase angle of the s-polarization component) on an angle of incidence θ1 in light made incident on the interface such as the light emitting surface from the inside of the light guide plate 130 and emitted from the interface. As shown in FIG. 5, a characteristic line 401 indicates the advance δp of the phase angle of the p-polarization component with respect to an angle incidence when a refractive index of a medium of the light guide plate 130 is 1.59. A characteristic line 402 indicates the advance δs of the phase angle of the s-polarization component with respect to the angle of incidence.

When the angle of incidence θ1 is a total internal reflection angle (a critical angle) θc or when the angle of incidence θ1 is 90°, advances of phase angles of p-polarization and s-polarization are equal but aspects of changes thereof are different. A characteristic line 403 indicates a phase difference δ(=δp−δs) between the p-polarization and the s-polarization. Specifically, amounts of phase changes of reflected light are different in the p-polarization and the s-polarization depending on the angle of incidence θ1 on the interface. The phase of the light continuously changes within a range of the angle of incidence θc to 90°. In particular, when the light is totally reflected at the angle of incidence θ1 equal to or larger than the total internal reflection angle θc and smaller than 90°, the phase difference δ between the p-polarization and the s-polarization occurs.

The advances δp and δs of the phase angle depend on the angle of incidence and reflection θ1 in the total internal reflection, a refractive index nLG of the light guide plate, and a refractive index of the air. When azimuths in which incident light and reflected light travel are the same, specifically, when the incident light travels in the light guide plate 130 in the φ=90 degrees direction and is totally reflected in the φ=90 degrees direction on the interface 320, if the incident light includes only an s-polarization component (or a p-polarization component) in the φ=0 degree direction, phase advance merely occurs and the s-polarization component is not converted into the p-polarization component. (This is because a slow axis is equivalent to 0° or 90° when the interface 320 is regarded as a retarder.) On the other hand, when incident light is totally reflected and changes to reflected light traveling in a different azimuth in the light guide plate 130, specifically, the incident light travels in the φ=90 degrees direction in the light guide plate 130 and is totally reflected in an azimuth other than φ=90 degrees, a part of polarization component in the φ=0 degree direction of the incident light is converted into a polarization component in the φ=90 degrees direction.

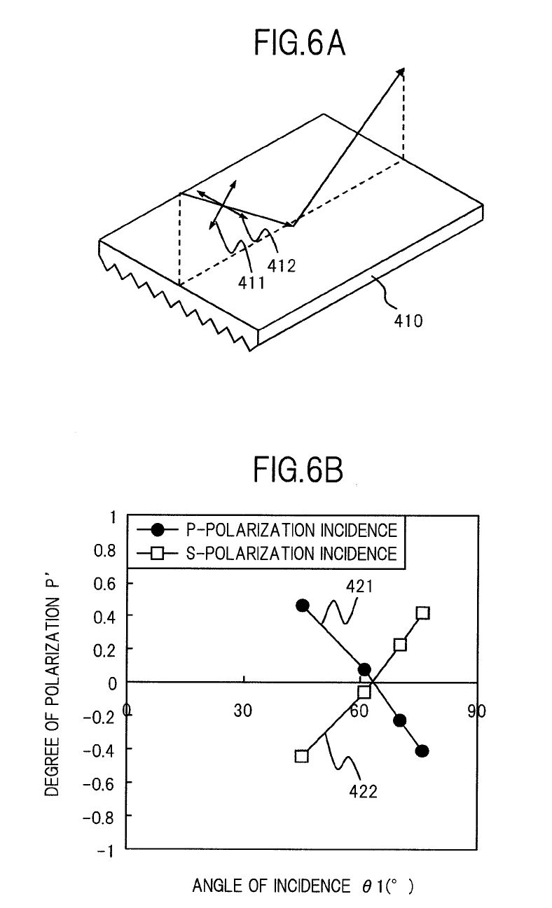

FIG. 6A is a diagram showing a state in which linearly polarized light 411 to be p-polarization and linearly polarized light 412 to be s-polarization are made incident on a prism substrate 410 in which prisms having an apex angle of 90 degrees and an isosceles triangular shape in cross-section are formed in a row on a rear side. In the following explanation, light traveling on the inside of the prism substrate 410 is totally reflected with a traveling azimuth changed, whereby polarization conversion occurs. In a state shown in the figure, the p-polarization 411 and the s-polarization 412 are made incident from an azimuth parallel to a ridge line of the prisms formed in the prism substrate 410, travels in the prism substrate 410, are totally reflected on slopes of the isosceles-triangular shaped prisms provided on the rear surface, and are emitted from the prism substrate 410. First, the p-polarization 411 and the s-polarization 412 made incident on the prism substrate 410 are totally reflected on the slope of any one of the isosceles-triangular shaped prisms in an azimuth different from an azimuth in which the p-polarization 411 and the s-polarization 412 travel. Then, the p-polarization 411 and the s-polarization 412 reach a slope formed opposed to the slope to be thereby totally reflected to be returned to an azimuth same as the traveling azimuth and emitted from the prism substrate 410.

As explained above, the p-polarization 411 and the s-polarization 412 are totally reflected in different azimuths on the slopes of the isosceles-triangular shaped prisms of the prism substrate 410, whereby polarization components of the p-polarization 411 and the s-polarization 412 are converted. FIG. 6B is a graph showing a result obtained by examining degrees of polarization of emitted lights of the p-polarization 411 and the s-polarization 412 made incident on the prism substrate 410. A characteristic line 421 indicates a degree of polarization of the emitted light at the time when the linearly polarized light 411 in the p-polarization direction is made incident on the prism substrate 410 shown in FIG. 6A. A characteristic line 422 indicates a degree of polarization of the emitted light at the time when the linearly polarized light 412 in the s-polarization direction is made incident on the prism substrate 410. A definition of a degree of polarization P′ shown in FIG. 6B is represented by the following Formula (2). The degree of polarization P′ depends on intensity Ip of p-polarization and intensity Is of s-polarization. When P′=1, this indicates completely linearly polarized light in the p-polarization direction. When P′=−1, this indicates completely linearly polarized light in the S-polarization direction.

$${P}^{′} = \frac{{I}_{p} - {I}_{s}}{{I}_{p} + {I}_{s}} \qquad ( 2 )$$

When the linearly polarized light 412 in the s-polarization direction is made incident on the prism substrate 410 at the angle of incidence θ1 in a range of 60 degrees to 80 degrees, a degree of polarization is −0.06 to 0.4. Therefore, the linearly polarized light 412 in the s-polarization direction at P′=−1 is made incident on the prism substrate 410 shown in FIG. 6A, whereby the linearly polarized light 412 is totally reflected on the slopes of the isosceles-triangular shaped prisms twice and polarization conversion occurs.

Polarization converting sections 131 formed on the rear surface of the light guide plate 130 in this embodiment are formed as prisms including slopes tilting to change a traveling azimuth of light guided by the light guide plate 130. The slopes are formed to face an azimuth different from a light guide azimuth (an azimuth of φ=±90 degrees), that is to say, a normal line on the slopes is an azimuth different from the light guide azimuth. Therefore, when light traveling in the light guide plate 130 in the azimuth of φ=90 degrees (or φ=−90 degrees) is totally reflected by the slope, a traveling azimuth of the light is also changed and a polarization component of the light is converted.

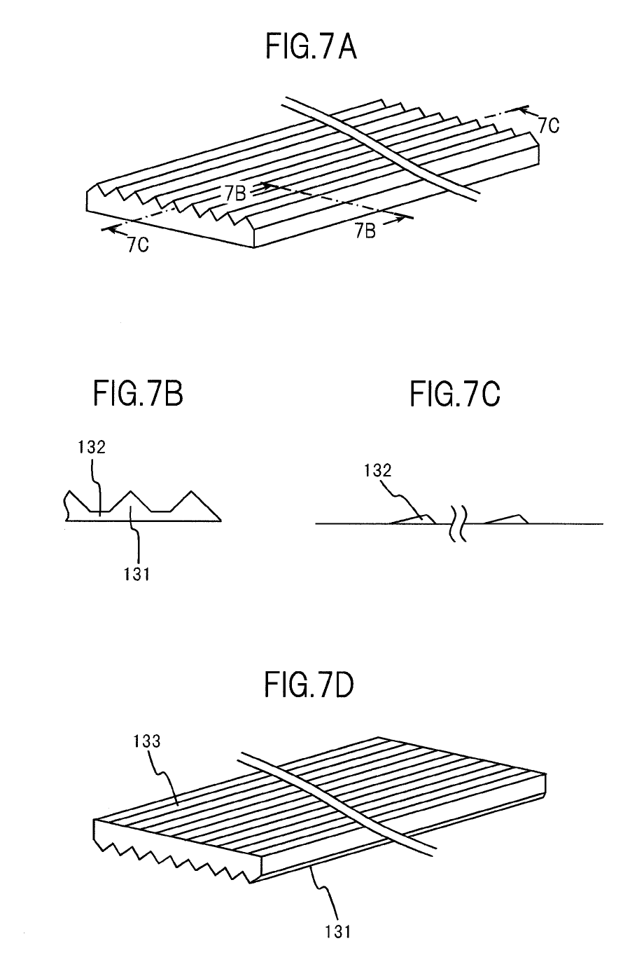

FIGS. 7A to 7D are diagrams showing states of the rear surface and the light emitting surface of the light guide plate 130 according to this embodiment. As shown in the figure, a plurality of prisms each having at least two slopes and having a triangular shape in cross-section are arranged on the rear surface of the light guide plate 130. The two slopes are formed to change light traveling in the light guide plate 130 and made incident from the light guide azimuth to a traveling azimuth different from the light guide azimuth. The light made incident on one of the two slopes from the light guide azimuth is changed to a different traveling azimuth and made incident on the other slope. The light made incident on the other slope is reflected again to bring the traveling azimuth of the light closer to the light guide azimuth and emitted from the prism. Therefore, a normal line of the two slopes has an azimuth angle in an azimuth different from the light guide azimuth. When the prism has a linear groove shape, the prism extends in an azimuth different from an azimuth (an azimuth angle=0°) perpendicular to the light guide azimuth, an angle formed by an azimuth extending in the linear groove shape and the light guide azimuth is suitably set to be equal to or smaller than 30 degrees (an azimuth in which the prism extends is suitably set to 60°φ≦120°. The angle is more desirably set to be equal to or smaller than 10 degrees (the azimuth in which the prism extends is more desirably set to 80°≦φ≦100°). In this embodiment, since the prism is formed in the linear groove shape, a ridge line or a valley line is formed and a plurality of prisms in which ridge lines or valley lines extend in one direction are formed in a row. Each of the prisms has two slopes tilting at a fixed angle arranged to form an apex angle b. Tilt angles of the two slopes are the same. Specifically, prism rows in which a plurality of prisms having an isosceles triangular shape in cross-section are arranged as the polarization converting sections 131 on the rear surface of the light guide plate 130. The polarization converting sections 131 can control a polarization state of light traveling in the light guide plate 130 by adjusting the apex angle b of the prisms or the azimuth angle φ of ridge lines or valley lines of the prisms (an azimuth in which the prisms having the linear groove shape extend). The polarization converting sections 131 have a function of a phase shifter for shifting the phases of p-polarization and the s-polarization. A pair of slopes inclining at an equal tilt angle with respect to the rear surface to form an apex angle are formed in each of the prisms of the prism rows in this embodiment. Light with a traveling azimuth changed by one slope is totally reflected by the other slope to return the traveling azimuth to the original azimuth. In this way, the light is totally reflected at least twice and the traveling azimuth of the light traveling in the light guide azimuth is returned, whereby efficiency of polarization conversion is improved. Each of the prisms of the prism rows formed as the polarization converting sections 131 on the light guide plate 130 may include three or more slopes or planes. The two slopes in the prism may tilt at different tilt angles. Even in these cases, the prisms having the slopes formed such that an azimuth in which a normal line tilts is not the light guide azimuth has a function of subjecting light traveling in the light guide azimuth to polarization conversion.

Emitting sections 132 as structures for emitting light guided in the light guide plate 130 to the light emitting surface is also provided on the rear surface of the light guide plate 130 on the reflective sheet 140 side. As shown in FIG. 7B, the emitting sections 132 in this embodiment are provided on valley lines in the prism rows viewed from the outside of the light guide plate. The emitting section 132 is realized by forming tilting surfaces having a tilt angle of 0.5 to 3 degrees in a plurality of places. FIGS. 7B and 7C are diagrams respectively showing states of a cross-section 7B-7B and a cross-section 7C-7C in FIG. 7A. As shown in these figures, the emitting sections 132 are projected (or recessed) and regularly or continuously arranged to overlap ridge lines or valley lines in positions to be the ridge lines or the valley lines (or positions to be both of the ridge lines and the valley lines) viewed from the inside of the light guide plate 130. The emitting sections 132 make light traveling in the light guide azimuth incident on the light emitting surface at an angle smaller than a critical angle. A p-polarization component is mainly emitted from the light emitting surface and an s-polarization component is reflected to the rear surface again. The light of the s-polarization component reached the rear surface is totally reflected by the prisms of the polarization converting sections 131, whereby a part of the light is converted into light of the p-polarization component.

FIG. 7D is a diagram showing a state of the light emitting surface of the light guide plate 130 according to this embodiment. Surface processing for solving unevenness of a light source caused by the light source sections 150 is applied to the light emitting surface. Unevenness of luminance due to the light source sections 150 tends to occur in azimuths of φ=0 degree and 180 degrees. Therefore, the shape of the light emitting surface is processed to improve uniformity of a distribution of luminance in an azimuth perpendicular to the light guide azimuth. Therefore, processing of a groove shape linear along the light guide azimuth at φ=90 degrees is applied to the light emitting surface according to the arrangement of the light source sections 150.

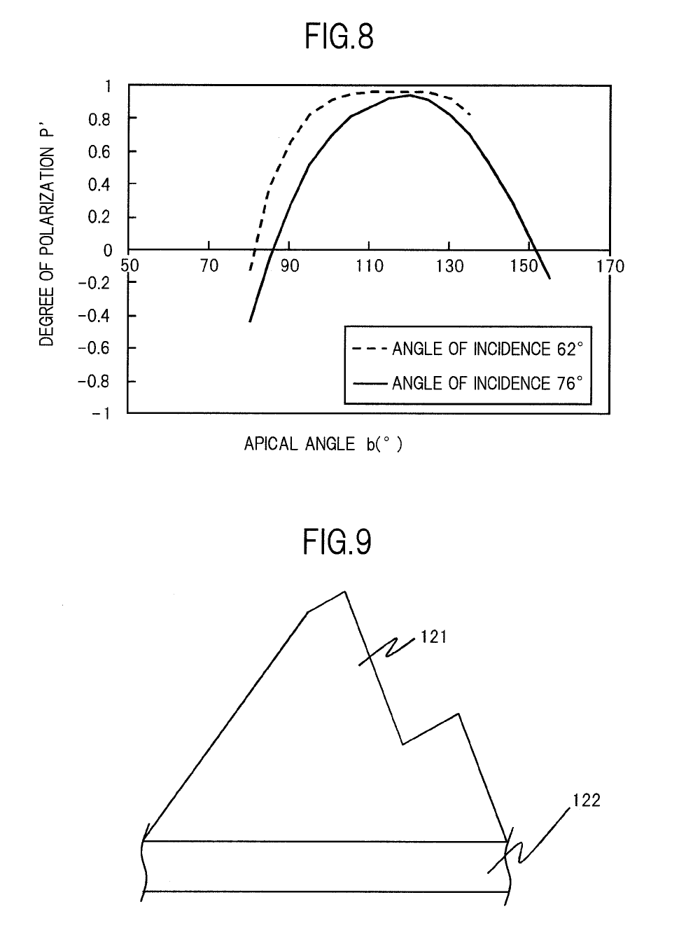

FIG. 8 is a graph showing a relation between the prism apex angle b and a degree of polarization of emitted light in the case in which linearly polarized light to be s-polarization is made incident from an azimuth of φ=90 degrees on the front side of a prism substrate in which prisms having ridge lines in an azimuth of φ=90° and having an isosceles triangular shape in cross-section are formed on the rear side in a row. In the figure, relations in the case of angles of incidence of 62 degrees and 76 degrees are plotted. These relations correspond to a case in which lights subjected to polarization conversion are emitted at emission angles of 62 degrees and 76 degrees from the light emitting surface of the light guide plate 130 including, on the rear surface, the prisms having ridge lines in an azimuth of φ=90° and having an isosceles triangular shape. The relations indicate degrees of polarization conversion of lights of s-polarized.

The lights at the emission angles of 62 degrees and 76 degrees correspond to emission angles of 60 to 80 degrees at which the luminance and the luminous intensity of light emitted from the light guide plate 130 are at peaks as explained above. In the case of the light guide plate 130 having the prisms formed in an isosceles triangular shape in section as in this embodiment, when an angle of incidence of a ray on the polarization converting sections 131 is equal to or larger than θc and smaller than 90°, the ray is totally reflected. When the ray is totally reflected, the phase difference δ between the p-polarization and the s-polarization indicated by the characteristic line 403 in FIG. 5 is finite. Therefore, the prism row having the ridge lines in the azimuth φ and the apex angle b explained above is provided, whereby the s-polarization component in the direction of φ=0° remaining in the light guide plate 130 is converted into a p-polarization component in the direction of φ=90°.

As shown in FIG. 8, at an angle at which the apex angle b is larger than 90 degrees, since the degree of polarization P′ of s-polarization (the degree of polarization: P′=−1) made incident on the light emitting surface of the light guide plate 130 from the azimuth of φ=90 degrees is large, a polarization conversion function is high. When the prism has a shape with the apex angle b set in a range of 100 degrees≦b≦130 degrees, the degree of polarization P′ is equal to or higher than 0.9 when the s-polarization traveling in the light guide plate 130 is emitted from the light guide plate 130 at an angle of 62 degrees, the polarization conversion function by the polarization converting sections 131 in the light guide plate 130 is high. The prism more desirably has a shape with the apex angle b set in a range of 110 degrees≦b≦130 degrees because the degree of polarization P′ is equal to or higher than 0.8 when the s-polarization traveling in the light guide plate 130 is emitted from the light guide plate 130 at both angles of 62 degrees and 76 degrees and the polarization conversion function by the polarization converting sections 131 in the light guide plate 130 is high. Such a range of angle setting for the apex angle b holds substantially in the same manner when the ridge line of the prism is in an azimuth in a range of 80 degrees≦φ≦100 degrees (or 260 degrees≦φ≦280 degrees).

When the prism has a shape with the apex angle b set in a range of 80 degrees≦b≦100 degrees and an azimuth angle of the ridge set in a range of 80 degrees≦φ≦100 degrees (or 260 degrees≦φ≦280 degrees), light made incident on one slope of the polarization converting sections 131 from the light guide direction (φ=90° is reflected on the other slope and emitted generally in the light guide direction again. Therefore, a change in a ray traveling direction due to the polarization converting sections 131 is small and it is easy to eliminate luminance unevenness of a light source for a groove shape or the like formed on the light emitting surface. As shown in FIG. 8, in this case, although the degree of polarization P′ in the case in which the s-polarization traveling in the light guide plate 130 is emitted at an emission angle of 76 degrees is in a range of −0.4 to 0.6 and the polarization conversion efficiency is lower than the peak, a polarization conversion effect can be obtained. Therefore, it is effective to set the apex angle b of the prism in the range of 80 degrees≦b≦100 degrees when the polarization conversion effect of the light guide plate 130 is obtained and in-plane uniformity of light source luminance is improved.

When the light guide plate 130 shown in FIGS. 7A to 7D is used, there is an effect of converting a polarization component in the direction of φ=0° to a polarization component in the direction of φ=90° in the light guide plate 130. The degree of polarization P of light made incident on the light emitting surface to be emitted at an emission angle of 61° from the light emitting surface is improved from 0% to 16%. In the case of an emission angle of 76°, the degree of polarization P is improved from 14% to 25%.

The prism sheet 120 includes a prism row of prisms each having at least two slopes and a ridge of the slopes extending in one direction. The prism sheet 120 includes, as shown in FIG. 9, a prism 121 and a base material 122.

As the base material 122 of the prism sheet, for example, it is possible to use an optically isotropic transparent member hardly having at least anisotropy of a refractive index in a plane such as a transparent film that is a triacetyl cellulose film, a non-extending polycarbonate film, or the like. It is also possible to use a transparent member with uniaxial anisotropy of a refractive index imparted in a plane by extending a film formed of polycarbonate resin or olefin resin in one direction. However, since these films have uniaxial anisotropy, it is desirable to set a slow axis of the films to 0° or 90° to prevent a phase difference from occurring in a polarization component, a polarization direction of which passing through the prism sheet 120 is φ=90°.

It is also effective to use polycarbonate resin or a PET (polyethylene terephthalate) film. However, since the PET film has biaxial anisotropy, like the film having uniaxial anisotropy, it is desirable to prevent a phase difference from occurring in a polarization component, a polarization direction of which passing through the prism sheet is φ=90°. As measures, in the same manner as explained above, the slow axis of the film only has to be arranged at 0° or 90°.

As the shape of the prism 121, for example, left and right slopes shown in FIG. 9 may have asymmetrical shapes. In this embodiment, the prism sheet 120 having a prism shape shown in FIG. 9 is explained. The sectional shape of the prism 121 is formed by a plurality of slopes having two kinds of principal tilt angles. Viewed from the vertex of the prism 121, at least three slopes are formed on a side relatively far from a light source. At least one of the slopes has a tilt in the opposite direction with respect to the other slopes when viewed from a light emission surface of the prism sheet 120. This is for the purpose of suppressing a change in a color that occurs when a view angle (a polar angle) is changed at an azimuth angle orthogonal to the prism ridge line. Since the prism sheet 120 according to this embodiment extracts a ray from the light guide plate 130 by transmitting the ray once, an amount of light returning to the light guide plate 130 is small. Polarization of a ray passing through the prism sheet 120 is less easily broken. The ray is emitted with a degree of polarization further intensified on the interface of the prism sheet 120. In the case of this embodiment, the prism sheet 120 is a prism sheet having an asymmetrical prism shape shown in FIG. 9. However, the prism sheet 120 is not limited to this shape and may be other shapes.

The diffusion sheet 110 is formed by, for example, a method of forming irregularities on the surface of a transparent polymer film of polyethylene terephthalate (PET), polycarbonate, or the like.

When the configuration of the first embodiment explained above is used, there is an effect that a ratio of a polarization component in the polarization direction φ=90° in light made incident on the prism sheet 120 and an amount of the light increases. Therefore, a transmission axis of the lower polarizer is arranged at an azimuth angle close to the polarization direction φ=90° (substantially parallel to the light guide direction), whereby an optical loss due to absorption in the lower polarizer 230 of light radiated from the surface light source 100 is reduced and the light utilization efficiency of the emitted light of the surface light source 100 in the liquid crystal panel 200 is improved. If the surface on the reflective sheet 140 side of the light guide plate 130 is formed in a shape shown in FIG. 7A, it is easy to form a mold. Even in a manufacturing method requiring a mold such as injection molding, it is easy to form the polarization converting sections 131 and the emitting sections 132. In this embodiment, in the prism rows of the polarization converting sections 131, the emitting sections 132 are provided on the valley lines viewed from the outer side of the light guide plate 130. However, the emitting sections 132 may be provided on the ridge lines viewed from the outer side of the light guide plate 130. It is advisable to form the emitting sections 132 to overlap the ridge lines or the valley lines in the prism rows of the polarization converting sections 131. The light emitting surface and the rear surface of the prism and a light incident surface from the light source sections 150 in the polarization converting sections 131 according to this embodiment are processed to be smooth to prevent irregular reflection as much as possible. Specifically, the light emitting surface, the rear surface, and the light incident surface and the polarization converting sections 131 and the emitting sections 132 are respectively processed as smooth surfaces rather than being processed as rough surfaces. The emitting sections 132 in this embodiment reflect light traveling on the inside in the light guide azimuth to reduce an angle of incidence on the light emitting surface to be smaller than the critical angle while keeping an azimuth in which the light traveling on the inside in the light guide azimuth travels. However, for example, it is also possible to reduce the angle of incidence on the light emitting surface to be smaller than the critical angle while changing an azimuth of the light traveling in the light guide azimuth such that a normal line of the tilting surfaces formed as the emitting sections 132 have an azimuth angle that shifts with respect to the light guide azimuth. In this case, not only a polar angle of the light traveling in the light guide azimuth but also an azimuth angle changes in the emitting sections 132 and a polarization component is also converted.

### Second Embodiment

A liquid crystal display device according to a second embodiment of the present invention is explained below.

This embodiment is different from the first embodiment in that, for example, a flat surface without a tilt is arranged between the prisms of the polarization converting sections 131 of the light guide plate 130 and in the shape of the emitting sections 132. Otherwise, this embodiment is substantially the same as the first embodiment. Explanation of similarities to the first embodiment is omitted.

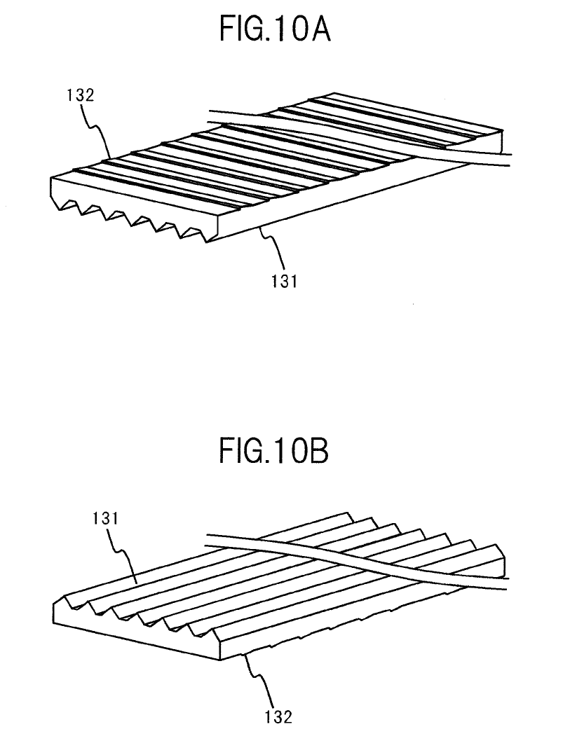

FIG. 10A is a diagram showing a state in which a surface on the prism sheet 120 side of the light guide plate 130 according to this embodiment is faced up. FIG. 10B is a diagram showing a state in which a surface on the reflective sheet 140 side of the light guide plate 130 according to this embodiment is faced up. As shown in FIG. 10A, the polarization converting sections 131 are configured by forming prisms, each of which includes at least two slopes, in a row and the polarization converting sections 131 are arranged on the reflective sheet 140 side. A flat surface is provided between two prisms in the polarization converting sections 131. As shown in FIG. 10A, the emitting sections 132 extend in a direction parallel to the side having the light incident surface. The emitting sections 132 are configured by discontinuously or regularly arranging slopes tilting at 0.5 to 3 degrees with respect to the light emitting surface. As shown in FIG. 10A, a flat portion is arranged between two prisms, whereby light can travel straight through the flat portion. Therefore, since amounts of light on the light source sections 150 side and the opposite side of the light source sections 150 side are uniform, fluctuation in an in-plane distribution of light due to the light source sections 150 can be suppressed and the luminance of the surface light source 100 is improved. In this embodiment, such a flat surface is formed in a valley between two prisms formed in a convex shape. However, the flat surface may be formed at the top of the prism formed in a convex shape.

### Third Embodiment

A liquid crystal display device according to a third embodiment of the present invention is explained below.

This embodiment is the same as the first embodiment in that the emitting sections 132 and the polarization converting sections 131 of the light guide plate 130 are provided on the reflective sheet 140 side and a shape for eliminating unevenness of a light source is provided on the prism sheet 120 side. Whereas the emitting sections 132 are provided among the prism rows as the polarization converting sections 131 to overlap the valley lines when viewed from the outer side of the light guide plate 130 in the first embodiment, in the third embodiment, the prism rows are arranged in a plurality of places at an interval in the light guide azimuth and the emitting sections 132 are formed among the prism rows discontinuously arranged. The third embodiment is different from the first and second embodiments at this point. Otherwise, this embodiment is substantially the same as the first and second embodiments. Explanation of similarities to the first and second embodiments is omitted.

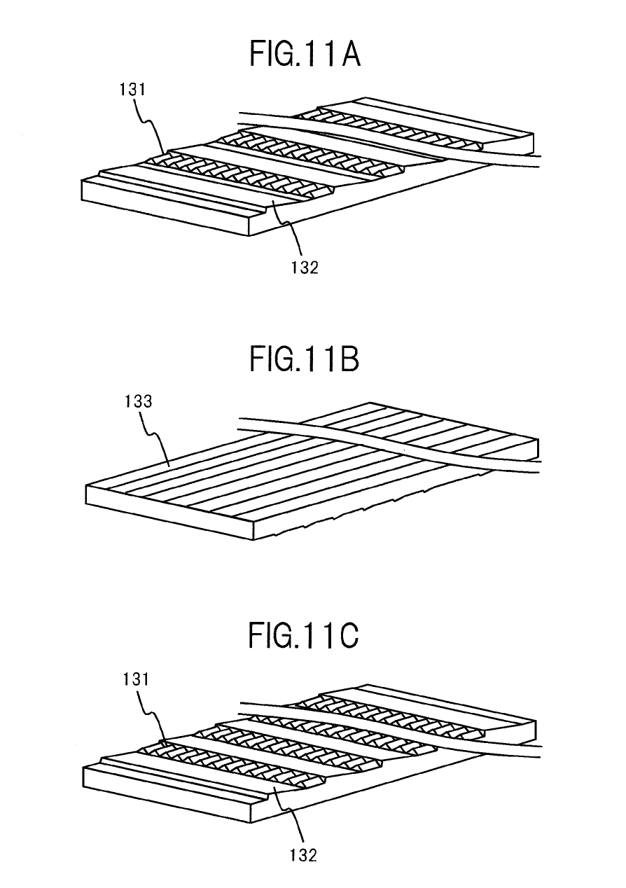

FIG. 11A is a diagram showing a state in which a surface on the reflective sheet 140 side of the light guide plate 130 according to this embodiment is faced up. FIG. 11B is a diagram showing a state in which a surface on the prism sheet 120 side of the light guide plate 130 according to this embodiment is faced up. As shown in FIG. 11A, the polarization converting sections 131 and the emitting sections 132 are alternately arranged on the reflective sheet 140 side in the light guide azimuth. By arranging the polarization converting sections 131 and the emitting sections 132 on the reflective sheet 140 side as shown in FIG. 11A, it is possible to attach a shape 133 for eliminating unevenness of a light source to the prism sheet 120 side and suppress fluctuation in an in-plane distribution of light due to the light source sections 150. As a result, the luminance of the surface light source 100 is improved.

If the polarization converting sections 131 and the emitting sections 132 are joined without a space on a surface on the reflective sheet 140 side as shown in FIG. 11C, it is possible to suppress light leakage from the section of the polarization converting sections 131.

### Fourth Embodiment

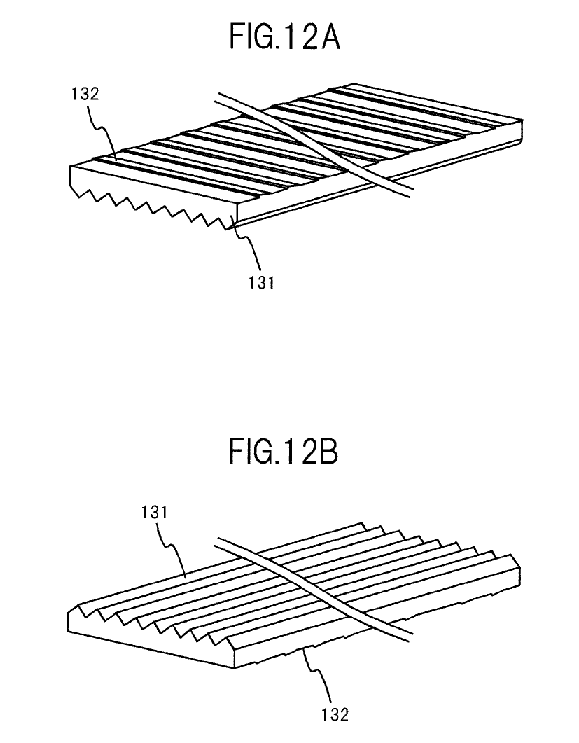

A liquid crystal display device according to a fourth embodiment of the present invention is explained below with reference to FIGS. 12A and 12B. FIG. 12A is a diagram showing a state in which a surface on the reflective sheet 140 side of the light guide plate 130 according to the fourth embodiment is faced up. FIG. 12B is a diagram showing a state in which a surface on the prism sheet 120 side of the light guide plate 130 according to the fourth embodiment is faced up. The fourth embodiment is different from the first to third embodiments in that the prism rows of the polarization converting sections 131 in the light guide plate 130 are formed on the light emitting surface and the emitting sections 132 are arranged on the rear surface of the light guide plate 130. Otherwise, the fourth embodiment is substantially the same as the first to third embodiments. Explanation of similarities to the first to third embodiments is omitted. Since the prism rows of the polarization converting sections 131 are arranged on the light emitting surface, polarization conversion occurs and light utilization efficiency of the surface light source 100 is improved.

Even when the polarization converting sections 131 are present on the light emitting surface of the light guide plate 130, as in the first embodiment, light having a high p-polarization component is emitted from the light guide plate 130 and light having a high s-polarization component tends to be left in the light guide plate 130. The left light of the s-polarization component is totally reflected twice and subjected to polarization conversion by the polarization converting sections 131. The light left in the light guide plate 130 and subjected to polarization conversion is totally reflected by the emitting section 132 to be made incident on the light emitting surface at an angle smaller than the critical angle. The light having the high p-polarization component is efficiently emitted.

### Fifth Embodiment

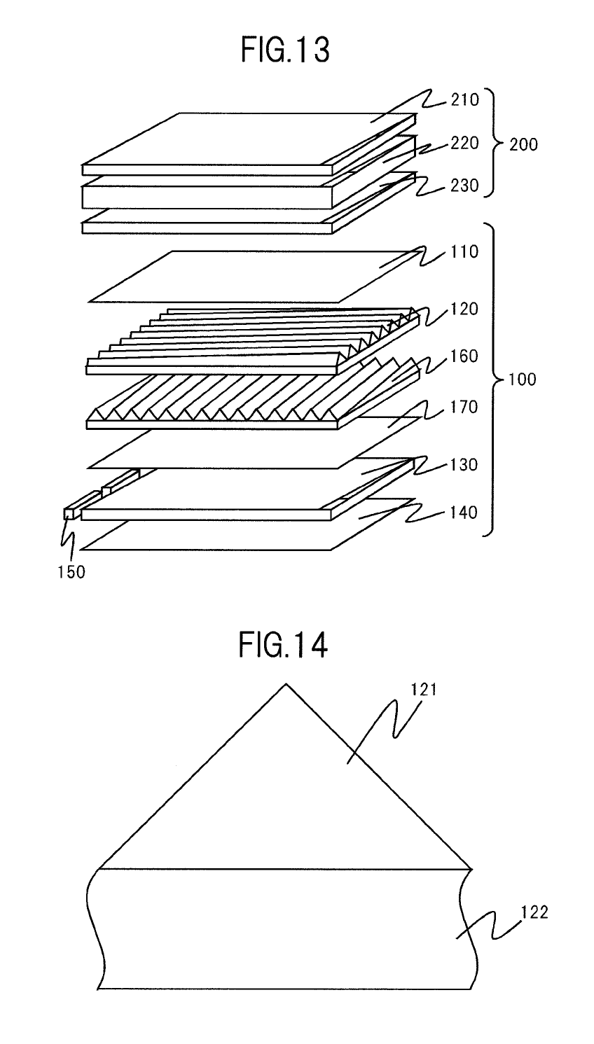

A liquid crystal display device according to a fifth embodiment of the present invention is explained below with reference to FIGS. 13 and 14. FIG. 13 is a diagram showing a state in which components included in the liquid crystal display device according to the fifth embodiment are separated. The fifth embodiment is different from the first to fourth embodiments in the number of members included in the surface light source 100 and in that two prism sheets 120 and 160 are used and in that the diffusion sheet 170 is used. Otherwise, the fifth embodiment is substantially the same as the first to fourth embodiments. In the following explanation, explanation concerning similarities to the first to fourth embodiments is omitted. As shown in FIG. 13, ridge line directions of the prism sheets 120 and 160 are arranged to be orthogonal to each other.

FIG. 14 is a diagram showing a state in which a cross-section of the prism sheet 120 or 160 according to the fifth embodiment is enlarged. As shown in the figure, as the shape of the prism 121, left and right slopes of the prism 121 are formed in a symmetrical shape. In other words, a prism having an isosceles triangular shape is used. The surface light source 100 in the fifth embodiment brings light emitted from the light emitting surface of the light guide plate 130 (raises the light) in a direction perpendicular to the liquid crystal panel 200 to gradually reduce the polar angle θ of an emitted ray through the diffusion sheet 170, the prism sheet 160 or 120. Light is condensed by the prism sheet 120 or 160. The number of optical sheets for raising the light emitted from the light guide plate 130 and condensing the light is different from that in the first to fourth embodiments.

The azimuth angle φ of light during emission from the light guide plate 130 contributing to front emission of the surface light source 100 is 90° (or 270°). The azimuth angle φ coincides with an azimuth angle having peak luminance during emission from the light guide plate 130. A ratio of emitted light at φ=90° is high in a polarization direction at φ=90°. It is possible to improve light utilization efficiency of the surface light source 100 by further improving a degree of polarization in this azimuth angle with the polarization converting sections 131.

### Sixth Embodiment

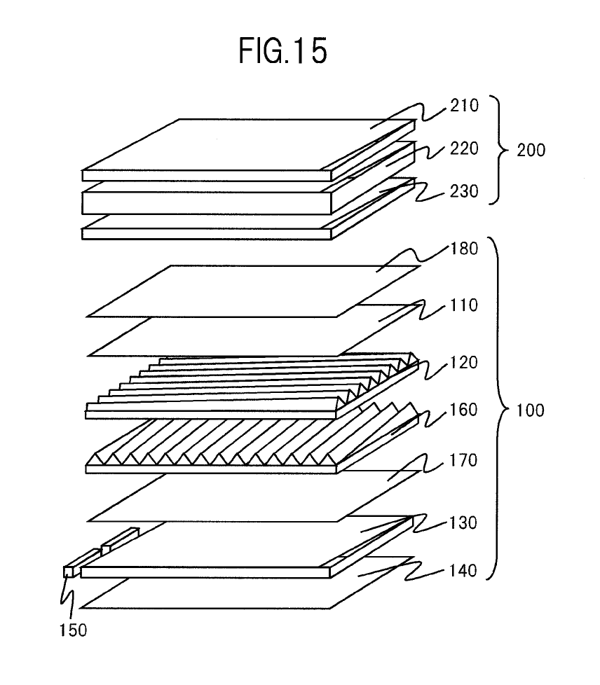

A liquid crystal display device according to a sixth embodiment of the present invention is explained below with reference to FIG. 15. FIG. 15 is a diagram showing a state in which components included in the liquid crystal display device according to the sixth embodiment are separated. The sixth embodiment is different from the fifth embodiment in that, for example, a reflective polarization film 180 is inserted between the liquid crystal panel 200 and the diffusion sheet 110.

A transmission axis of the reflective polarization film 180 extends in a direction substantially the same as the direction of the transmission axis of the lower polarizer 230. The reflective polarization film 180 reflects polarized light in a direction perpendicular to the transmission axis. Therefore, a light amount of return light to the light guide plate 130 is larger than that in the fifth embodiment. The return light as light in the polarization direction orthogonal to the transmission axis of the lower polarizer 230 is subjected to polarization conversion by the light guide plate 130 and caused to travel to the reflective polarization film 180 again with components parallel to the transmission axis of the lower polarizer 230 increased. Consequently, light utilization efficiency of the surface light source 100 is improved.

DBFF or BEF-RP is often used in the reflective polarization film 180. The sixth embodiment is substantially the same as the fifth embodiment except that, for example, the reflective polarization film 180 is provided as explained above. Therefore, explanation of the sixth embodiment is omitted. In the sixth embodiment, as in the fifth embodiment, the prism sheets 120 and 160 and the diffusion sheet 170 are provided. The reflective polarization film 180 may be provided in the same manner in the first to fifth embodiments in which one prism sheet is provided. In the sixth embodiment, the reflective polarization film 180 is arranged between the diffusion film 110 and the lower polarizer 230. However, the reflective polarization film 180 may be arranged in other places as long as the reflective polarization film 180 is arranged between the lower polarizer 230 and the light guide plate 130.

### Seventh Embodiment

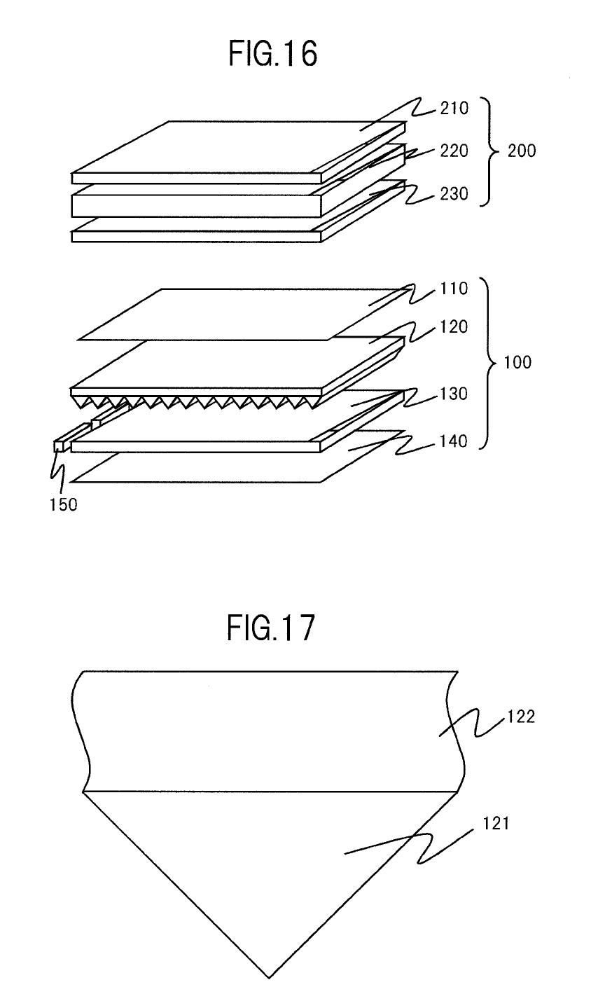

A liquid crystal display device according to a seventh embodiment of the present invention is explained below with reference to FIGS. 16 and 17. FIG. 16 is a diagram showing a state in which components included in the liquid crystal display device according to the seventh embodiment are separated. In the configuration according to the seventh embodiment, the number of components included in the surface light source 100 and the shape of the prism sheet 120 are different from those in the first to fourth embodiments. Otherwise, the seventh embodiment is the same as the first embodiment. Explanation of components same as those in the first to fourth embodiments is omitted.

FIG. 17 is a cross-section in which a part of the prism sheet 120 according to the seventh embodiment is enlarged. In the seventh embodiment, the prisms 121 in the prism sheet 120 are provided on the light guide plate 130 side of the base material 122. The seventh embodiment is different from the first to fourth embodiments at this point. Light emitted from the light guide plate 130 is made incident on the prism 121, totally reflected on a slope on the opposite side of a prism slope on which the light is made incident, and raised to the front (the normal direction of the liquid crystal panel 200). In-plane uniformity and expansion of a luminance view angle of a light source are realized by the diffusion sheet 110. The diffusion sheet 110 desirably has a characteristic that a polarization state of light emitted from the prism sheet 120 is not changed as much as possible.

In the configuration according to the seventh embodiment, since a ray from the light guide plate 130 is extracted by transmitting the ray once, an amount of light returning to the light guide plate 130 is small. Therefore, polarization of the ray transmitted through the prism sheet 120 is less easily broken. The ray is emitted with a degree of polarization further intensified on the interface of the prism sheet 120. Therefore, a degree of polarization of the surface light source 100 is improved by improving a degree of polarization of light emitted from the light guide plate 130. Light absorbed by the lower polarizer 230 decreases and light utilization efficiency of the surface light source 100 is improved.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A liquid crystal display device comprising:
one or a plurality of light source sections;
a light guide plate including a light emitting surface that guides, from a side edge, light from the one or plurality of light source sections and emits the light in a planar shape; and
a liquid crystal panel including a lower polarizer on a side opposed to the light emitting surface, wherein
the lower polarizer has a transmission axis in a direction generally along a light guide azimuth in which the light guide plate guides the light,
the light guide plate includes a polarization converting section on at least one of the light emitting surface and a rear surface of the light emitting surface, and
the polarization converting section reflects light made incident from the light guide azimuth in a different traveling azimuth and further reflects the light reflected in the different traveling azimuth to bring the traveling azimuth closer to the light guide azimuth to thereby convert polarization of the light traveling from the light guide azimuth.

2. The liquid crystal display device according to claim 1, wherein the polarization converting section includes a prism having at least two slopes including a slope that reflects the light made incident from the light guide azimuth in the different traveling azimuth and a slope that further reflects the light reflected to the light reflected in the different traveling azimuth to bring the traveling azimuth closer to the light guide azimuth.

3. The liquid crystal display device according to claim 2, wherein
the prism is formed in a triangular shape in cross-section by the at least two slopes, and
normal lines of the at least two slopes are in an azimuth different from the light guide azimuth.

4. The liquid crystal display device according to claim 3, wherein the prism is formed in a shape of a linear groove extending in an azimuth different from an azimuth perpendicular to the light guide azimuth.

5. The liquid crystal display device according to claim 3, wherein the polarization converting section includes a prism row in which a plurality of the prisms are formed in a row, and
each of the prisms in the prism row has a shape of a liner groove extending in an azimuth different from an azimuth perpendicular to the light guide azimuth.

6. The liquid crystal display device according to claim 3, wherein the prism is formed in an isosceles triangular shape in cross-section, and the at least two slopes are formed symmetrical.

7. The liquid crystal display device according to claim 5, wherein
an angle formed by the azimuth in which each of the prisms extends and the light guide azimuth is equal to or smaller than 10 degrees, and
an apex angle b of the prism formed in a triangular shape in cross-section is in a range of 80 degrees≦b≦130 degrees.

8. The liquid crystal display device according to claim 7, wherein the apex angle b is in a range of 80 degrees≦b≦100 degrees.

9. The liquid crystal display device according to claim 7, wherein the apex angle b is in a range of 110 degrees≦b≦130 degrees.

10. The liquid crystal display device according to claim 3, wherein
the light emitting surface and the rear surface of the light guide plate are formed smooth, and
the at least two slopes of the prism included in the polarization converting section are formed smooth.

11. The liquid crystal display device according to claim 3, wherein the light guide plate includes a plurality of emitting sections that make light traveling on an inside of the light guide plate in the light guide azimuth incident on the light emitting surface at an angle smaller than a critical angle to thereby emit the light from the light emitting surface.

12. The liquid crystal display device according to claim 11, wherein the plurality of emitting sections reflect, in the light guide azimuth, the light traveling on the inside in the light guide azimuth and make the light incident on the light emitting surface at an angle smaller than the critical angle.

13. The liquid crystal display device according to claim 11, wherein the plurality of emitting sections are discontinuously arranged in a plurality of places on the light emitting surface or the rear surface.

14. The liquid crystal display device according to claim 11, wherein the polarization converting section and the plurality of emitting sections are arranged on the rear surface.

15. The liquid crystal display device according to claim 14, wherein a groove-like pattern is formed linearly along the light guide azimuth on the light emitting surface according to arrangement of the one or plurality of light source sections.

16. The liquid crystal display device according to claim 14, wherein
the polarization converting section includes a prism row in which a plurality of the prisms are formed in a row,
each of the prisms in the prism row has a shape of a liner groove extending in an azimuth different from an azimuth perpendicular to the light guide azimuth, and
the plurality of emitting sections are respectively arranged to overlap at least one of a ridge line and a valley line in the prism row.

17. The liquid crystal display device according to claim 14, wherein
the light guide plate includes the polarization converting section on the rear surface,
the polarization converting section includes a plurality of prism rows in which a plurality of the prisms are formed in rows,
each of the prisms in each of the prism rows has a shape of a linear groove extending in an azimuth different from an azimuth perpendicular to the light guide azimuth,
the plurality of prism rows are discontinuously arranged along the light guide azimuth, and
at least one of the plurality of emitting sections is arranged to be interposed between two of the plurality of prism rows discontinuously arranged.

18. The liquid crystal display device according to claim 1, wherein
a reflective polarizer is arranged between the lower polarizer and the light guide plate,
the reflective polarizer reflects light of a polarization component in a direction orthogonal to the transmission axis to the light guide plate side, and
the polarization converting section is formed on the rear surface of the light guide plate.

19. The liquid crystal display device according to claim 1, wherein the light guide plate includes a polarization converting section that totally reflects, at least twice, light traveling on an inside in the light guide azimuth to change a traveling azimuth of the light on at least one of the light emitting surface and the rear surface of the light emitting surface and converts polarization of the light.
